(19) United States
(12) Patent Application Publication
(10) Pub. No.: US 2005/0091558 A1
(43) Pub. Date: Apr. 28, 2005

(54) System, method and program product for detecting malicious software

(75) Inventors: David M. Chess, Mohegan Lake, NY (US); James S. Luke, Isle of Wight (GB)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 10/696,200

(22) Filed: Oct. 28, 2003

(51) Int. Cl. G06F 11/00

(52) U.S. Cl. 714/38

(57) ABSTRACT

System, method and program product for detecting malicious software within or attacking a computer system. In response to a system call, a hook routine is executed at a location of the system call to (a) determine a data flow or process requested by the call, (b) determine another data flow or process for data related to that of the call, (c) automatically generate a consolidated information flow diagram showing the data flow or process of the call and the other data flow or process. After steps (a-c), a routine is called to perform the data flow or process requested by the call. A user monitors the information flow diagram and compares the data flow or process of steps (a) and (b) with a data flow or process expected by said user. If there are differences, the user may investigate the matter or shut down the computer to prevent damage.

### BACKGROUND OF THE INVENTION

This invention relates generally to computer systems, and deals more particularly with detection of malicious computer attacks such as caused by computer viruses, worms and hackers.

Malicious computer attacks, such as manual “hacker” attacks, computer viruses and worms are common today. They may attempt to delete, corrupt or steal important data, disable a computer or conduct a denial of service attack on another computer.

A manual attempt to “hack” a victim's server or workstation begins when a (hacker) person at a remote workstation attempts in real time to gain access to the victim's server or workstation. This typically begins by the hacker entering many combinations of user IDs and passwords, hoping that one such combination will gain access to sensitive software or data in the server or workstation. A hacker may also transmit an exploitation program which automatically exploits vulnerabilities in a victim's server, as would a hacker do manually.

A computer virus is a computer program that is normally harmful in nature to a computer. Computer viruses are received via several media, such as a computer diskette, e-mail or vulnerable program. Once a virus is received by a user, it remains dormant until it is executed by the user or another program. A computer worm is a computer program similar to a computer virus, except that a computer worm does not require action by a person or another program to become active. A computer worm exploits some vulnerability in a system to gain access to that system. Once the worm has infected a particular system, it replicates by executing itself. Normally, worms execute themselves and spawn a process that searches for other computers on nearby networks. If a vulnerable computer is found, the worm infects this computer and the cycle continues.

Computer attacks are typically received via the network intranet or Internet, and are targeted at an operating system. Often, a computer virus or worm is contained in a file attached to an e-mail. Computer firewalls can prevent some types of attacks transmitted through a network. However, a computer exploit can use encryption technologies to transmit information through firewalls. Alternately, the computer exploit may be embedded in an image that can pass through the firewall.

Most computer attacks have a characteristic “signature” by which the attack can be identified. An intrusion detection system can also be used to detect known computer attacks by matching key words of the attack program to a known signature. However, until a computer attack becomes known and its signature determined, it can avoid the intrusion detection system.

Another known method for identifying malicious software is to heuristically check system operation to identify unusual behavior. For example, if a system iterates through all files or all files of a certain category, and changes or deletes them, this may be considered unusual behavior. As another example, it may be considered unusual behavior for software to iterate sequentially through the file system overwriting the start of each executable file. As another example, if an application connects to the Internet when the current workload of the system does not require such a connection, this would be considered unusual behavior. Heuristic checking software was previously known to detect these types of unusual/suspicious behavior. The heuristic checking software monitors all programs that are executing to detect these types of behavior and flags an alert to the user, hopefully before too much damage is done.

It was also known to identify suspicious network communications as follows. Firewalls detect all attempts to connect to the Internet and are capable of blocking certain types of messages. The user is required to configure the security policy, although most systems have default settings that are suitable for the average user. The security policy determines the type of connections that are allowed to pass through the firewall. For example, the security policy may allow HTTP access on a particular port to download HTML. However, the firewall will block other types of messages. If an attempt is made to pass such a message through the firewall, a dialogue box is generated that alerts the user to the prohibited message. The dialogue box may also also ask the user whether such a message should be allowed to pass through the firewall.

Information flow diagrams are known for use in analyzing software during development. See “Certification of Programs for Secure Information Flow” by Dorothy E. Denning and Peter J. Denning in Communications of ACM, 20(7):504-513, July 1977 for details of information flow techniques. This publication is hereby incorporated by reference as part of the present disclosure.

An object of the present invention to facilitate the detection of malicious software within or attacking a system.

### SUMMARY OF THE INVENTION

The invention resides in a system, method and program product for detecting malicious software within or attacking a computer system. In response to a system call, a hook routine is executed at a location of the system call to (a) determine a data flow or process requested by the call, (b) determine another data flow or process for data related to that of the call, (c) automatically generate a consolidated information flow diagram showing the data flow or process of the call and the other data flow or process. After steps (a-c), a routine is called to perform the data flow or process requested by the call. A user monitors the information flow diagram and compares the data flow or process of steps (a) and (b) with a data flow or process expected by said user. If there are differences, the user may investigate the matter or shut down the computer to prevent damage.

The information flow diagram may represent the physical and virtual locations of information entities at stages of a processing activity. The set of system functions which are monitored may include: open file, copy file to memory, copy memory to register, mathematical functions, write to file, and network or communication functions.

### BRIEF DESCRIPTION OF THE DRAWINGS

FIG. 1A is an information flow diagram generated in accordance with one example of the present invention.

FIG. 1B is a schematic diagram of an apparatus in accordance with the present invention displaying the information flow diagram of FIG. 1A;

FIG. 2A is a flow diagram of a software interrupt in accordance with the prior art.

FIG. 2B is a flow diagram of hooking a software interrupt in accordance with the present invention.

FIG. 3 is another information flow diagram generated in accordance with another example of the present invention.

FIG. 4 is another example of an information flow diagram generated in accordance with another example of the present invention.

FIG. 5 is another example of an information flow diagram generated in accordance with another example of the present invention.

FIG. 6 is a flow chart of hook routines used to generate the information flow diagram of FIG. 5.

FIG. 7A schematically illustrates a call by a software application where a hook routine is located at the call address.

FIG. 7B schematically illustrates that after the hook routine of FIG. 7A executes, it calls an operating system routine to perform the function requested by the application.

FIG. 7C schematically illustrates that after the operating system routine of FIG. 7B executes, it returns to the software application that made the call in FIG. 7A.

### DETAILED DESCRIPTION OF THE PREFERRED EMBODIMENTS

The present invention provides a system, method and program product for monitoring and displaying the activity of a computer system in real time as an information flow diagram. This permits an operator to determine if the activity appears consistent with the bona fide work requested of the computer system. The information flow diagrams show the physical and virtual location of information entities at all stages of their processing and the operations, such as the copying, encryption and transmission of information. The information flow diagrams are generated in real time as the information is being processed and moved about the computer.

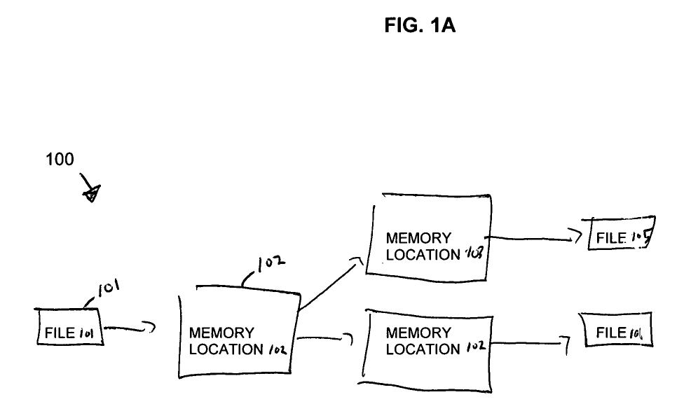

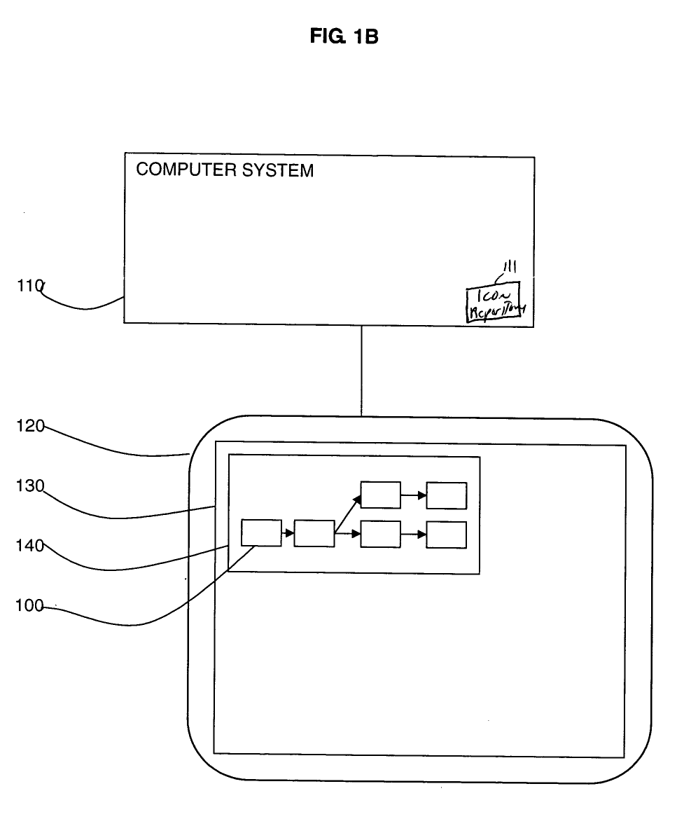

FIG. 1A shows an information flow diagram 100 for copying a file and renaming the copied file. A file 101 is saved at a first memory location 102. The file 101 is then copied from the first memory location 102 to a second memory location 103. At this time, the same file 101 concurrently resides at both the first and second memory locations 102 and 103. Then, the copy of file 101 in memory location 103 is renamed as file 105, while the copy of file 101 in memory location 102 retains its original name of file 101.

FIG. 1B illustrates a computer system 110 with a display screen 120 and a program providing a graphical user interface 130 for the display screen. In accordance with the present invention, computer system 110 generates information flow diagrams such as flow diagram 100 in real time representing the operations of the computer system. The information flow diagrams, such as flow diagram 100 are displayed (as display 140) on display screen 120 using the graphical user interface 130.

In order to automatically construct the information flow diagrams, system calls are “hooked”. “Hooking” is the insertion of an additional routine at a call location in an operating system or other program and relocating the original, called routine from the call location. In accordance with the present invention, the additional routine is used to monitor system activity. After the additional routine is executed, it calls the operating system routine to perform the function requested by the software application, so that the function of the operating system is preserved. After the operating system function executes, it returns to the application, so the application will not realized any difference in function. Software interrupt hooking is used to study internal operations of the operating system, movement of data and any other activity characteristic of malicious software. Memory hooking involves copying DOS subroutines to a different memory location and writing an alternative subroutine in its place. The additional routine generally calls the original routine once it has completed its processing. In this way, the underlying function of the operating system is maintained.

In DOS and early Windows environments, system calls were named “software interrupts”. Software interrupts are program generated interrupts that stop the current processing in order to request a service provided by an interrupt handler. Applications typically use this mechanism to get different services from the operating system. A software interrupt causes the processor to stop what it is doing and start a new subroutine. It does this by suspending the execution of the code on which it was working, saving its place and states, and then executing the program code of the subroutine. Once the subroutine has been executed, the program code is continued from where it was interrupted. The software interrupts comprise mainly BIOS and DOS subroutines called by programs to perform system functions.

To call a given interrupt handler, a calling program needs to be able to find the program code that carries out the function. Part of the processor memory is reserved for a map called an interrupt vector table providing the addresses for the program code for carrying out an interrupt. Calling a software interrupt requires setting up registers and then executing the interrupt. For example, interrupt “21H” in the DOS operating system is used for the main file I/O functions. Interrupt “21H” instructions can be used to open a file and read the contents of a file into memory. Using further interrupts, individual bytes of data can be copied from specific memory locations to registers, and mathematical operations can be performed. The resulting data can then be copied from the register back to alternative memory locations and ultimately written to file or communications ports. Software written in a high level language such as Java or C++ is compiled into these low level instructions by the compiler. This low level of programming at which software interrupts operate is the level at which many computer viruses work. Later versions of Windows operating systems include similar functions for hooking operating system calls. Later versions of Windows, which are not based on DOS operating systems, are based on higher level system calls. Low level software interrupts still exist and are available to be hooked. It is desirable in the present invention to hook the lowest level calls where possible.

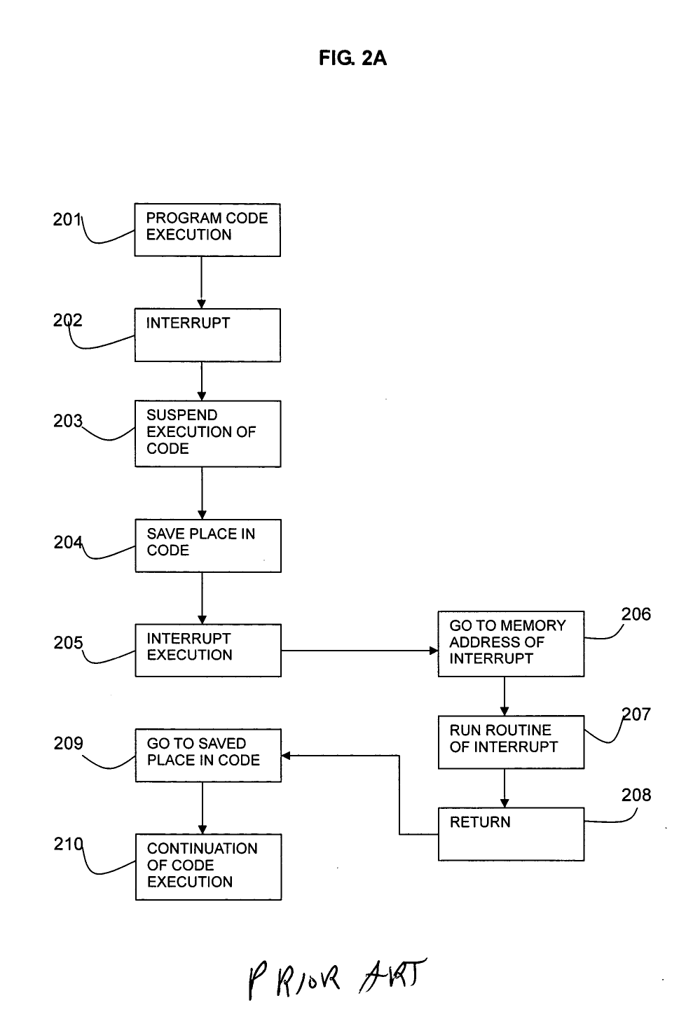

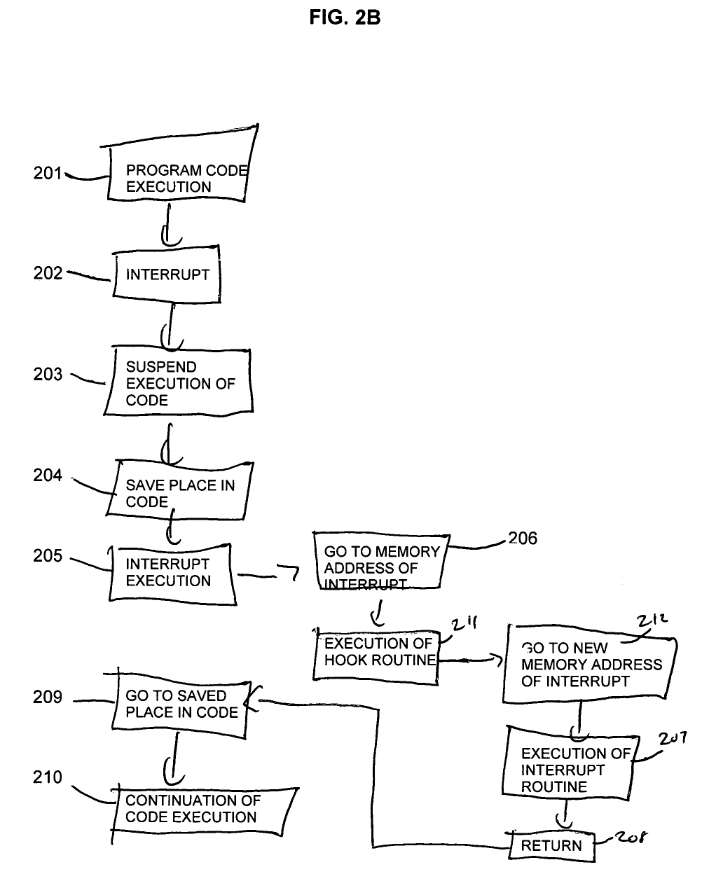

FIG. 2A illustrates the interruption of program operation to carry out a software interrupt, according to the Prior Art. During execution of a software application/program code (which could be a computer virus, worm or other malicious software) (step 201), an interrupt occurs (step 202). The interrupt suspends the execution of the program code (step 203) and saves the place of the program code (204). The interrupt is then executed (step 205) by going to a memory address of the interrupt subroutine (step 206). The subroutine is executed (step 207). At the end of the subroutine, a return (step 208) sends the operation back to the saved place in the program code (step 209). The program code execution is then continued (step 210).

FIG. 2B illustrates the steps of hooking the software interrupt shown in FIG. 2A. The same series of steps 201-206 are carried out as with FIG. 2A where the operation jumps to the address of the interrupt. However, in place of the interrupt subroutine 207 is a hooking routine which then executes (step 211 instead of step 207). After the hooking routine completes its execution, it jumps to a new memory address which contains the original interrupt routine of step 207 (step 212). The original interrupt then executes (step 207) and returns (step 208) to the saved place in the program code (step 209). The program code then continues execution as before with step 210.

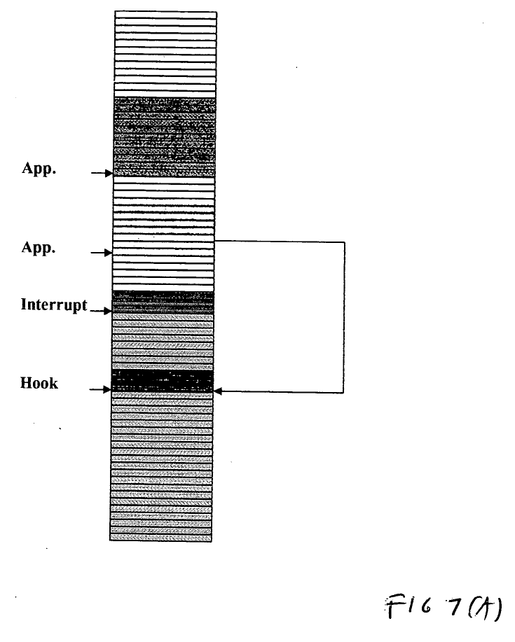

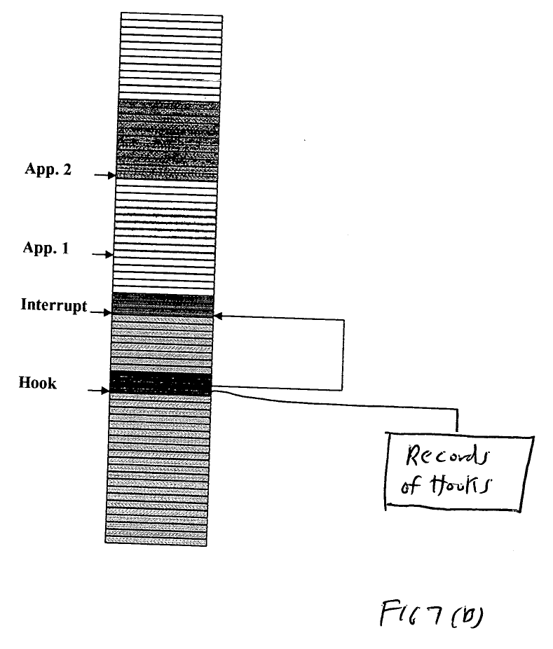

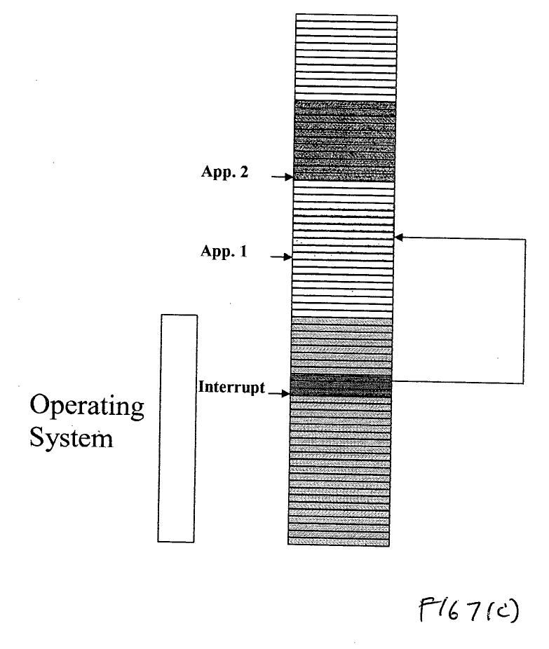

FIGS. 7A-C further illustrate the process of FIG. 2B. In FIG. 7A, an application (which could be a computer virus, worm or other malicious software) makes a call requesting an operating system function. However, a hook routine has been inserted at this call location. FIG. 7B illustrates that after the hook executes, it calls the operating system function that was originally intended by the application. FIG. 7C illustrates that after the operating system function executes, it returns to the application that made the original call.

In the present invention, a series of interrupt hooks such as hook 207 are located and implemented to automatically generate an information flow diagram in real time. One example is to track an individual byte of information by hooking interrupts for loading data into memory, copying data from one location to another and writing the data back to a file. In this and other examples, the hooks monitor and display system operation. There is sufficient detail in the information flow diagrams to monitor and display the operation of the computer system without flooding the user with excessive information. In one embodiment of the present invention, the interrupts which are hooked include open file, copy file to memory, copy memory to register, mathematical functions, write to file, and network functions. Each one of these hooks generates an icon or other graphical representation of the current operation to be performed by the original routine at the call address. The following are examples. When a file is to be opened by an original routine at the call address, the hooking routing will create an icon which represents the file, a label on the icon for the file name, and a memory location for the file. When the file is to be moved from one location to another location by an original routine at another call address, the hooking routing will create an adjacent icon which represents the file, a label on the adjacent icon for the file name, a new memory location of the file, and an arrow between the two icons pointing to the adjacent icon to indicate a file transfer. When the file is to be sent out on the Internet to a destination IP address by the original routine at another call address, the hooking routing will generate a third icon which illustrates the Internet and a fourth icon which illustrates the destination device on the Internet, and an arrow leading from the second icon to the Internet. Other icons can represent an encryption operation, a mathematical operation, an insertion of an IP address operation, etc. These information flows can instantly reveal suspicious activities.

As another example, by hooking a series of calls, it is possible to track and illustrate when an individual byte of data is read from disk to a memory location, the data from that memory location is copied to a register, a mathematical operation is performed on the data in the register, and the result of the mathematical operation is written to an alternative location (i.e. memory or disk). Even at the byte level, a meaningful information flow diagram can be generated.

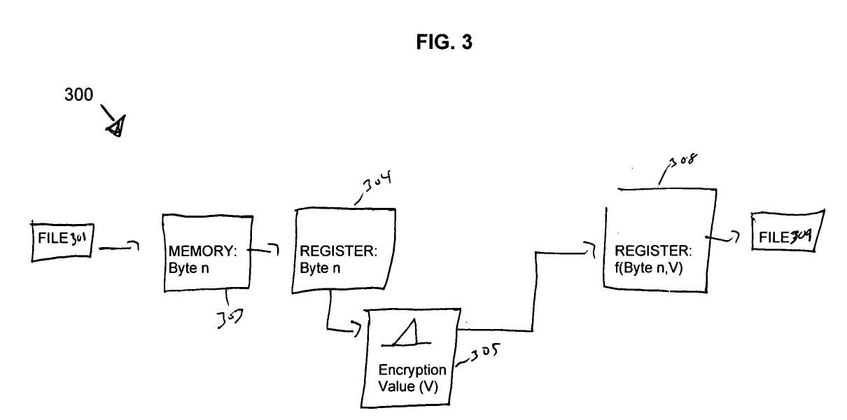

FIG. 3 illustrates an example of an information flow diagram 300 to reveal malicious software which reads a name-password pair from a password file. The malicious software operates by accessing the file, encrypting the name-password pair, embedding the encrypted information into another file, and then e-mailing this other file to the author of the malicious software. FIG. 3 shows a file 301 (represented graphically by a rectangular icon to represent the file and a file name therein) which is accessed. The file 301 is loaded into a series of bytes “n” in memory 303 (represented graphically by a square icon to represent memory). The “n” bytes in memory 303 are copied to a register 304 (represented graphically by another square icon to represent a register). Then, an encryption operation 305 (represented graphically by a square icon with a magicians hat), using an encryption value (“V”), is applied to the values held in the register 304. The encrypted data is then copied to a register 308 and embedded in a second file 309. To create the foregoing information flow diagram, the call to the routine to create file 301 has been replaced with a hook that reads the call to learn that file 301 is to be created and create a record of file 301. The record indicates the file name, length and location. Then, the hook routine creates the icon for file 301 with the file name within the icon. (There can be a repository 111 within system 110 containing a library of icons, an indication what each icon represents and an indication where descriptive text and numbers may be located within the icon. For each icon to be included in an information flow diagram, the hook routine can select the proper icon from this library corresponding to the computer element or function, i.e. file, memory, register, encryption, etc., and specify the descriptive text and numbers, if any, to include in the icon and the location on the screen for the icon. In this embodiment, the hook routine also specifies arrows between successive icons as described below. Alternately, the hook routine need only generate the event data, by writing the event data to a file, and then call a separate graphics application to generate the information flow diagram based on the event data.) After creating the icon, the hook routine calls the original routine to actually create file 301. The call to the routine to load file 301 into memory 303 has been replaced with a hook that reads the call to learn that the contents of file 301 is to be loaded into memory 303, and to create a new record for file 301, i.e. its file name, length and location. Then, the hook routine creates the icon for memory 303 with the byte numbers in the icon and the arrow leading from the file 301 icon to the memory 303 icon. The call to the routine to load these contents of memory 303 into register 304 has been replaced with a hook that reads the call to learn that the contents of memory 303 is to be loaded into register 304, and to create a new record for file 301, i.e. its file name, length and location. Then, the hook routine creates the icon for register 304 with the byte numbers in the icon and the arrow leading from the memory 303 icon to the register 304 icon. The call to the routine to encrypt the specified bytes of register 304 has been replaced with a hook that reads the call to learn that the specified bytes of register 304 are to be encrypted, and to create a new record for the file, i.e. its file name, length and location. Then, the hook routine creates the icon for the encryption 305 with the encryption value in the icon and the arrow leading from the register 304 icon to the encryption 305 icon. The call to the routine to write the encrypted value into register 308 has been replaced with a hook that reads the call to learn that the encrypted number is to be written into register 308, and to create a record for the file, i.e. its file name, length and location. Then, the hook routine creates the icon for the register 308 with the byte number and encryption value in the icon and the arrow leading from the encryption icon 305 to the register 308 icon. The call to the routine to write the encrypted value from register 308 into file 309 has been replaced with a hook that reads the call to learn that the contents of this register is to be written into file 309, and create a new record for the file, i.e. its file name, length and location. Then, the hook routine creates the icon for the file 309 with the file name within the icon and the arrow leading from the register 308 icon to the file 309 icon. Each of the hook routines compares the name, location and length of data that is the subject of the current call to the existing records for previous calls to determine if the subject of the current call is the same as the subject of a previous call. If not, then the hook routine creates a new information flow diagram. If so, then the hook routine creates its icon and arrows and tacks it onto the end of an existing information flow diagram to continue the existing information flow diagram. Thus, each of the hook routines will join its icon to the end of the proper icon series that is currently being displayed, as generated by previous hook routines for the same data flow. The information flow diagram 300 is displayed on display screen 120 in real time, i.e. as the information flow and the icons are generated. After each hook routine completes is execution, it calls the operating system function that was originally intended by the software application, for example, to copy a file into memory or to encrypt a file.

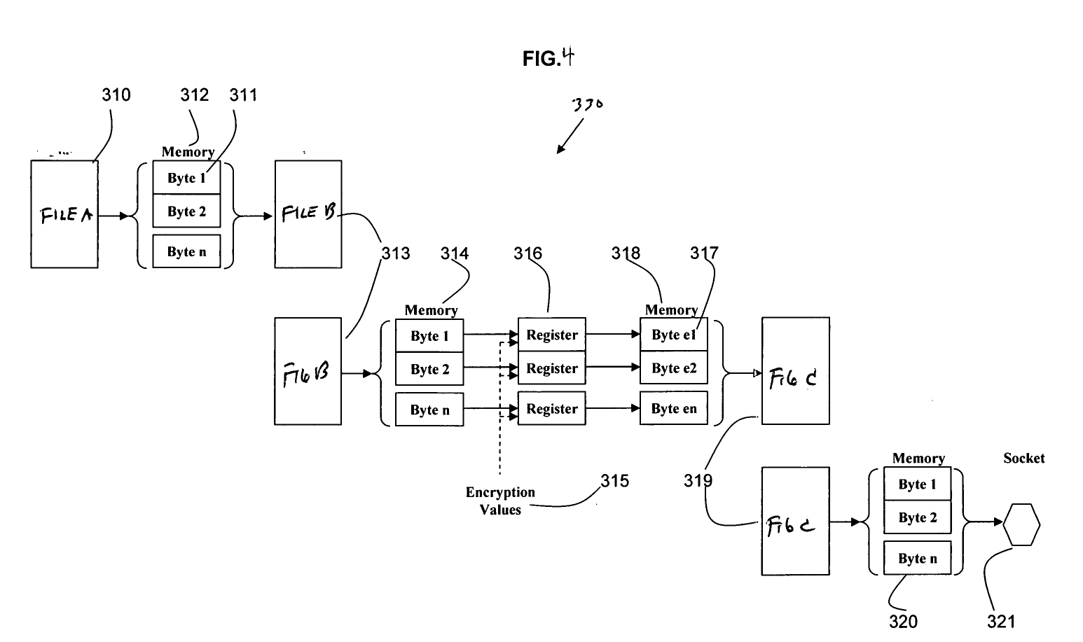

FIG. 4 illustrates another information flow diagram 330 to reveal malicious software which reads and amends a file. A file A is read from disk and then amended. The amended version, file B, is saved and encrypted. The encrypted version, file C, is attached to an e-mail and sent to a communications port of the computer system. There are three stages to the process shown in FIG. 4. Each of the three stages is shown in separate levels. In the first stage, file A (step 310) is loaded into a series of bytes 311 in memory 312 and copied to file B (step 313). The respective hook routines for the first stage generate the icon for file A, the icon for the memory 312, the arrow from the file A icon to the icon for memory 312, the upper icon for file B and the arrow from the icon for memory 312 to the upper icon for file B. The names of the call routines which will undertake the operations illustrated in FIG. 4 can be provided in the flow diagrams as well, for example, by listing the operation on the arrows. In the second stage of the process, file B is loaded into a series of bytes in memory 314 and each byte of file B in memory is copied to a byte in register 316. Encryption values 315 held in a separate register (not shown) are applied to each of the bytes in register 316 and an encryption operation is carried out. The resultant values are copied to a different set of bytes 317 in memory 318, and are written to a file C (step 319). The respective hook routines for this second stage of operation generate the lower icon for file B, the icon for memory 314, register 316, memory 318, the upper icon for file C and the arrow from the lower icon for file B to the icon for memory 314, the arrows from memory 314 to the icon for register 316 with a label for the encryption values 315, the arrows from the icon for register 316 to the icon for memory 318 and the arrow from the icon for memory 318 to the upper icon for file C. In the third stage of the process, file C (step 319) is loaded into a series of bytes in memory 320 and written to a socket 321. The respective hook routines for the third stage of the process generate the lower icon for file C, the icon for memory 320, the icon for socket 321, the arrow from the lower icon for file C to the icon for memory 320, and the arrow from the icon for memory 320 to the icon for socket 321. The information flow diagram 330 is displayed on display screen 120 in real time, i.e. as the information flow and the icons are generated. After each of the foregoing hook routines is executed, it calls the operating system routine to perform the desired function. When this operating system routine is completed, it returns to the software application that made the initial call.

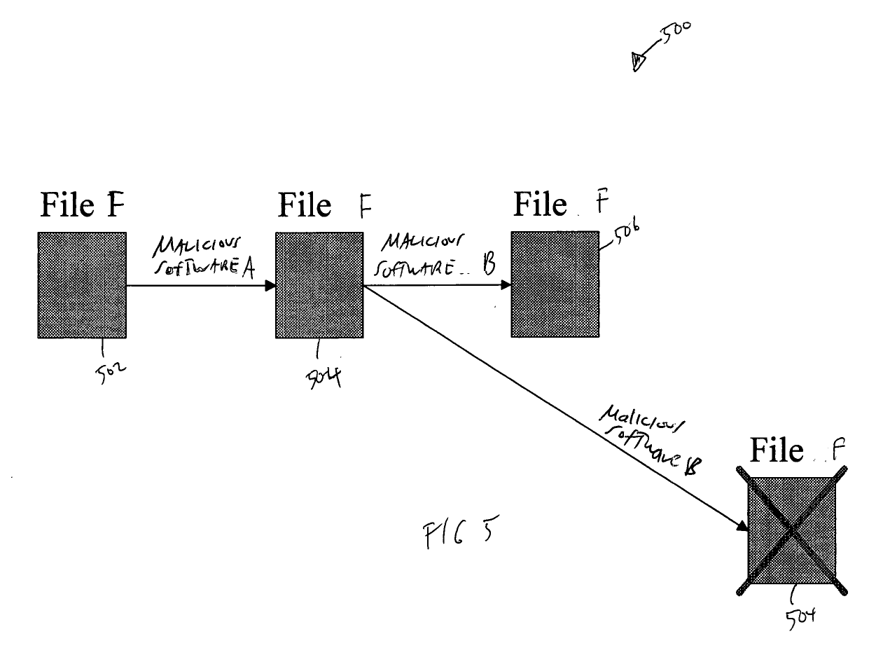

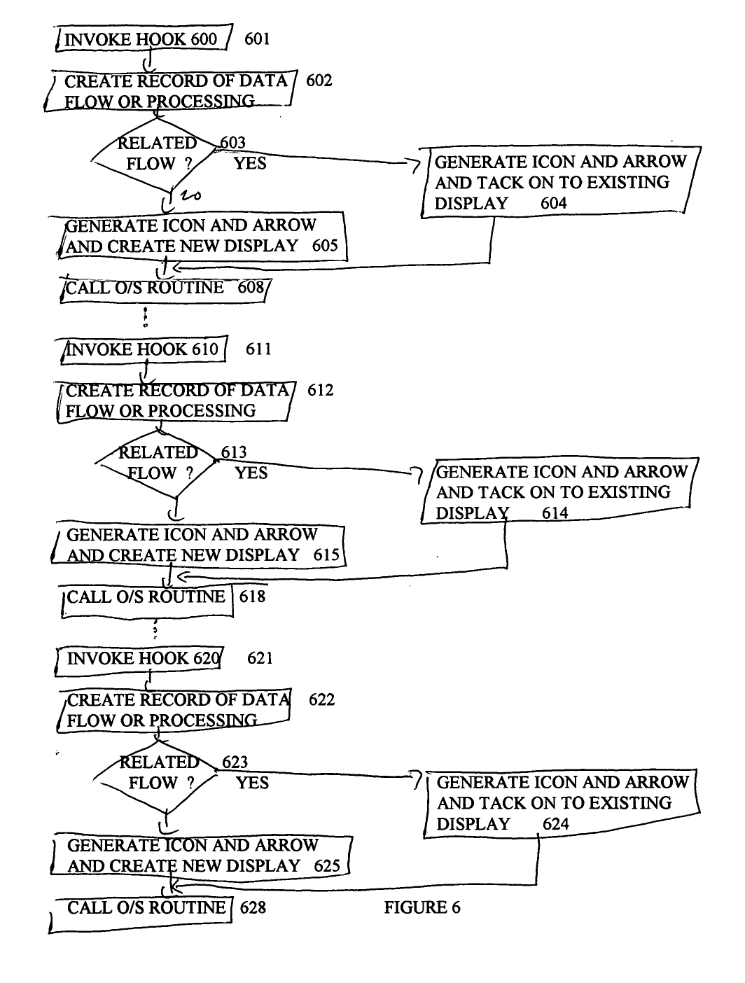

FIG. 5 illustrates another information flow diagram 500 to reveal malicious software. The information flow is as follows. Malicious software A reads a file F from a memory location 502 and then writes file F to a different memory location 504. Then, malicious software B reads file F from memory location 504, writes file F to a memory location 506, and then deletes the copy of file F from memory location 504. The information flow diagram is generated by hooks as illustrated in FIG. 6. A hook 600 is located at the call location for writing the file F from memory location 502 to memory location 504. The hook 600 creates a record stating the name of the file F, its size, the location from which it will be copied and the location to which it will be written (step 602). Hook 600 then looks for a record for a data flow or process for related data, i.e. same file name and current location (decision 603). In the illustrated example, there is no such record at this time, and this will be the first icon in the information flow diagram (decision 603, no branch). (If there was such a record, decision 603, yes branch, then the icon to be generated by hook 600 would be tacked on to the end of the existing information flow diagram in step 604).) Hook 600 then generates the icons for file F in locations 502 and 504, and the arrow between them as illustrated in FIG. 5 (step 605). Then, the hook calls the actual, operating system routine to read the file F from memory location 502 and write file F to memory location 504 (step 608). (This operating system routine, after execution, will return to the malicious software A that made the original call.)

Another hook 610 is located at the call location for writing file F from memory location 504 to memory location 506. When called by the malicious software B (step 611), hook 610 creates another record for the file stating the name of the file, its size, the location from which it will be copied and the location to which it will be written (step 612). Then, hook 610 compares the parameters of the file, i.e. name of the file, its size and its current location to the existing records to learn if there is a related data flow or process indicating that the flow of this file up to the present time is currently displayed (decision 613). In the illustrated example, this is the case; such a related record was made by hook 600. So hook 610 generates the icon for file F in memory location 506 and the arrow from memory location 504 to memory location 506 (step 614). Then, hook 610 calls the actual routine to read file F from memory location 504 to memory location 506 (step 618). (Referring again to decision 613, no branch, if there was no related data, then hook 610 would begin a new flow diagram.)

A third hook 620 is located at the call location for deleting file F from memory location 504. When called by the malicious software B (step 621), hook 620 creates another record for file F stating the name of the file, its size and the location from which it will be deleted (step 622). Then, hook 620 compares the parameters of the file, i.e. name of the file, its size and its current location to the existing records to determine if there is a related data flow or process, and therefore whether the flow of file F up to the present time is currently displayed (decision 623). In the illustrated example, this is the case. So, hook 620 generates the icon for the deleted file F from memory location 504 and the arrow from existing file F at memory location 504 to deleted file F at memory location 504 (step 625). Then, hook 620 calls the actual routine to delete file F from memory location 504 (step 628).

In another example, an information flow diagram illustrates a file being read from disk and written to a database (i.e. attaching a document to a e-mail), reading the file from the database and writing the file to a communications port (i.e. replicating databases). Both of these activities would be expected if the user had just created and sent an e-mail. However, if the file being copied to a database had not recently been attached by the user and some form of encryption was shown by the information flow diagram, the activity would not be expected, and therefore, would be suspicious. Consider another example where malicious software e-mails a confidential presentation to a competitor. An information flow diagram will reveal this activity, although the destination may not be shown. The user can identify malicious activity if the user has not attempted to e-mail the presentation to anyone. If the computer system 110 is not expected to be carrying out the activity illustrated by any of the respective information flow diagrams 300, 330 or 500, the user can investigate the matter or shut down the computer system before damage occurs.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

1. A method for detecting malicious software within or attacking a computer system, said method comprising the steps of:
in response to a system call, executing a hook routine at a location of said system call to (a) determine a data flow or process requested by said call, (b) determine another data flow or process for data related to that of said call, (c) automatically generate a consolidated information flow diagram showing said data flow or process of said call and said other data flow or process, and after steps (a-c), (d) call a routine to perform said data flow or process requested by said call.

2. A method as set forth in claim 1, wherein a user monitors said information flow diagram and compares the data flow or process of steps (a) and (b) with a data flow or process expected by said user.

3. A method as set forth in claim 1, wherein said information flow diagram illustrates locations of said data at stages of a processing activity.

4. A method as set forth in claim 1, wherein said system call is selected from the set of: open file, copy file to memory, copy memory to register, mathematical functions, write to file, and network or communication functions.

5. A method as set forth in claim 1, wherein said system call is a software interrupt of an operating system.

6. A method as set forth in claim 1, wherein said system call causes a processor to stop its current activity and execute said hook routine.

7. A method as set forth in claim 1 wherein said system call is made by malicious software.

8. A system for detecting malicious software in a computer system, said system comprising:
means, responsive to a system call, for executing a hook routine at a location of said system call to (a) determine a data flow or process requested by said call, (b) determine another data flow or process for data related to that of said call, (c) automatically generate a consolidated information flow diagram showing said data flow or process of said call and said other data flow or process, and after steps (a-c), (d) call a routine to perform said data flow or process requested by said call; and
means for displaying said information flow diagram.

9. A system as set forth in claim 8, wherein said information flow diagram illustrates locations of said data at stages of a processing activity.

10. A system as set forth in claim 8, wherein said system call is selected from the set of:
open file, copy file to memory, copy memory to register, mathematical functions, write to file, and network or communication functions.

11. A system as set forth in claim 8, wherein said system call is a software interrupt of an operating system.

12. A system as set forth in claim 8, wherein said system call causes a processor to stop its current activity and execute said hook routine.

13. A system as set forth in claim 8 wherein said system call is made by malicious software.

14. A computer program product for detecting malicious software in a computer system, said computer program product comprising:
a computer readable medium;
program instructions, responsive to a system call, for executing a hook routine at a location of said system call to (a) determine a data flow or process requested by said call, (b) determine another data flow or process for data related to that of said call, (c) automatically generate a consolidated information flow diagram showing said data flow or process of said call and said other data flow or process, and after steps (a-c), (d) call a routine to perform said data flow or process requested by said call; and wherein
said program instructions are recorded on said medium.
